(19) United States
(12) Patent Application Publication
(10) Pub. No.: US 2002/0024029 A1
(43) Pub. Date: Feb. 28, 2002

(54) Method and system for reading radiation image information

(75) Inventor: Satoshi Arakawa, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/939,704

(22) Filed: Aug. 28, 2001

(30) Foreign Application Priority Data
Aug. 28, 2000 (JP) 256597/2000

(51) Int. Cl. G03B 42/08

(52) U.S. Cl. 250/584

(57) ABSTRACT

Disclosed herein is an apparatus for reading radiation image information. The apparatus employs a storable phosphor sheet, which comprises a storable phosphor having an oblique orientation with respect to the thickness direction of the sheet. The direction of the optical axis of a collective lens, for collecting photostimulated luminescent light emitted from the storable phosphor sheet onto the light-receiving surface of a line sensor, is approximately aligned with the orientation of the storable phosphor.

### BACKGROUND OF THE INVENTION

1. Field of the Invention

The present invention relates to a method and apparatus for reading radiation image information, and more particularly to a method and apparatus for reading radiation image information stored in a storable phosphor sheet, by a line sensor.

2. Description of the Related Art

Computed radiographic apparatuses utilizing a storable phosphor (stimulatable phosphor) have extensively been put to practical use. The storable phosphor stores part of radiation energy when exposed to radiation, and emits photostimulated luminescent light according to the stored energy when exposed to excitation light such as visible light, laser light, etc. In the computed radiographic apparatus, the radiation image information of a subject, such as a human body, etc., is temporarily recorded on a storable phosphor sheet having the storable phosphor stacked on a support body. The storable phosphor sheet emits photostimulated luminescent light when scanned with excitation light such as laser light, etc. The photostimulated luminescent light is detected photoelectrically by photoelectric read means, and an image signal representing the radiation image information is obtained. After this image signal has been read, the storable phosphor sheet is irradiated with erasing light and emits the radiation energy remaining therein.

The image signal obtained by these computed radiographic apparatuses is subjected to image processing, such as a gradation process, a frequency process, etc., suitable for image observation and reading. The processed image signal is recorded on film as a visible image for diagnosis (final image), or displayed on a high-definition CRT display, so that it can be used for doctor's diagnosis, etc. On the other hand, if the aforementioned storable phosphor sheet is irradiated with erasing light to remove residual radiation energy, the sheet can store and record radiation image information again and can be used repeatedly Japanese Unexamined Patent Publication Nos. 60(1985)-111568, 60(1985)-236354, 1(1989)-101540, etc., disclose a radiation image information reading apparatus employed in the aforementioned computed radiographic apparatuses. The radiation image information reading apparatus is equipped with a line light source as an excitation light source, a line sensor as photoelectric read means, and scan means. The line light source is used for irradiating line excitation light to a phosphor sheet. The line sensor includes a large number of photoelectric conversion elements arrayed along the longitudinal direction (hereinafter referred to as a main scanning direction) of a line portion of the sheet irradiated with the excitation light by the line light source. The scan means is used for relatively moving one of (1) the line light source and the line sensor and (2) the phosphor sheet with respect to the other in a direction (hereinafter referred to as a sub scanning direction) substantially perpendicular to the main scanning direction.

The radiation image information reading apparatus is capable of shortening the time needed to read photostimulated luminescent light, making the system compact, and reducing cost, because it employs the line light source and the line sensor to realize excitation in line form and reading in line form.

However, in the case of the transmission construction where a line light source and a line sensor are disposed separately on the opposite sides of a phosphor sheet 50, as shown in FIG. 7, the phosphor layer 50a of the phosphor sheet 50 emits photostimulated luminescent light M according to radiation energy carrying radiation image information, when excited with excitation light L emitted from the excitation light source. The photostimulated luminescent light M is transmitted through a support body 50b that can transmit photostimulated luminescent light, and is incident on a photoelectric conversion element 21 which is a light intercepting element. When this occurs, the excitation light L scatters in the interior of the phosphor sheet 50 after it is incident on the sheet 50, and furthermore, the photostimulated luminescent light M which is emitted from the phosphor sheet 50 by irradiation of the excitation light L scatters in the interior of the sheet 50 during the time that the photostimulated luminescent light M is emitted from the surface of the phosphor sheet 50. Because of these scattering effects, the photostimulated luminescent light M spreads from the width dL Of the excitation light L to width dM. Thus, spreading of photostimulated luminescent light cannot be avoided.

The case of the reflection construction, in which a line light source and a line sensor are disposed on the same side with respect to a phosphor sheet, also has the same problem as the case of the transmission construction.

As can be seen from FIG. 5, in the case of a line sensor where the width dp of each photoelectric element 21 (in the sub scanning direction perpendicular to the main scanning direction) is less than the width dM of photostimulated luminescent light (in the sub scanning direction), a high-quality image is not obtained, because there is a great leakage of the photostimulated luminescent light, and also because the light-collecting efficiency becomes worse.

For this reason, the present applicant has disclosed in Japanese Unexamined Patent Publication No. 2000-2955 that the light-collecting efficiency for the line sensor is enhanced by preventing spreading of photostimulated luminescent light. A storable phosphor sheet is partitioned by light-reflecting partition walls into a large number of small cells corresponding to a region from which photostimulated luminescent light is emitted. Diffusion of the excitation light incident on a predetermined range (line portion) on the phosphor sheet is limited within the small cells by preventing the excitation light from diffusing indefinitely. In this manner, photostimulated luminescent light is emitted only from approximately the same line portion as the line portion on which line excitation light is incident, and spreading of the photostimulated luminescent light is prevented.

However, the phosphor sheet, which is partitioned by light-reflecting partition walls into a large number of small cells corresponding to the emission region of photostimulated luminescent light, in addition to the complexity of the process of fabricating the sheet, has the possibility of a drawback that the presence of partition walls in the phosphor sheet will lesson the efficiency of storing and reading radiation image information. Besides, there is an unsolved problem that the direction of the photostimulated luminescent light emitted from the interior of the phosphor cannot be fixed. The spreading of the photostimulated luminescent light results not only from diffusion of the excitation light but also from the scattering of the photostimulated luminescent light within the sheet interior produced during the time that the photostimulated luminescent light is emitted from the phosphor sheet surface. The aforementioned apparatus, however, can prevent the diffusion of excitation light but cannot prevent the scattering of the photostimulated luminescent light produced within the sheet interior.

### SUMMARY OF THE INVENTION

The present invention has been made in view of the circumstances mentioned above. Accordingly, it is the primary object of the present invention to provide a radiation image information reading method and a radiation image reading apparatus which are capable of preventing excitation light and photostimulated luminescent light from scattering in the interior of a sheet, enhancing both excitation efficiency and photostimulated luminescence efficiency, and collecting photostimulated luminescent light with increased efficiency.

The radiation image information reading method of the present invention is characterized in that it employs a storable phosphor sheet comprising a storable phosphor having orientation obliquely within a certain plane with respect to the thickness direction of the sheet, and that the direction of the optical axis of a collective lens, for collecting photostimulated luminescent light emitted from the storable phosphor sheet onto a line sensor described later, is approximately aligned with the orientation of the storable phosphor.

In accordance with the present invention, there is provided a method of reading radiation image information, comprising the steps of: (a) preparing a storable phosphor sheet comprising a storable phosphor which has orientation obliquely within a plane with respect to the direction of thickness of the storable phosphor sheet; (b) linearly irradiating excitation light to a portion of the surface of the storable phosphor sheet in a direction perpendicular to the plane by a line light source to read the radiation image information stored in the storable phosphor sheet; (c) collecting photostimulated luminescent light emitted from the linearly irradiated portion, or from a portion of a back surface of the storable phosphor sheet corresponding to the linearly irradiated portion, by a large number of collective lenses, having an optical axis parallel with the orientation of the storable phosphor, and disposed in a longitudinal direction of the linearly irradiated portion of the storable phosphor sheet; (d) receiving the photostimulated luminescent light collected by the collective lenses and then performing photoelectric conversion on the photostimulated luminescent light, by a line sensor comprising a plurality of photoelectric conversion elements arrayed in at least the longitudinal direction; and (e) relatively moving one of (1) the line light source and line sensor and (2) the phosphor sheet with respect to the other in a direction differing from the longitudinal direction, and serially reading output of the photoelectric conversion element according to the movement.

The “storable phosphor with orientation” refers to a storable phosphor of a type where photostimulated luminescent light produced by irradiation of excitation light is emitted in a certain direction. The storable phosphor used in the present invention has orientation obliquely with the thickness direction of a substrate 60, as illustrated in FIG. 8. That is, the storable phosphor is characterized in that photostimulated luminescent light produced by excitation light is emitted obliquely in the direction of arrow Z with respect to the surface of the substrate 60.

As disclosed in “Micro Optics News (Vol. 15, No. 12, Apr. 25, 1997,” an alkali halide (MeX:A) phosphor with an oblique pillar-shaped crystal has excellent sharpness and sensitivity. Therefore, it is preferable that the storable phosphor in the present invention be an alkali halide (MeX:A) phosphor. The letter “Me” represents alkali metel, the “X” halogen, and “A” an activator such as Eu, Tl, Ga, Bj, etc.

Recent advances in semiconductor processing techniques have made perceptible increases in the number of pixels, enhancements in sensitivity, noise reduction, and reductions in image size. Therefore, it is preferable that the photoelectric conversion elements constituting the line sensor be charge-coupled devices (CCDs).

To improve light-collecting efficiency, it is also preferable that the collective lens be a SELFOC lens.

In accordance with the present invention, there is also provided a system for reading radiation image information, comprising: (a) a storable phosphor sheet comprising a storable phosphor which has orientation obliquely within a plane with respect to the direction of thickness of the storable phosphor sheet; (b) a line light source for linearly irradiating excitation light to a portion of the surface of the storable phosphor sheet in a direction normal to the plane to read the radiation image information stored in the storable phosphor sheet; (c) a large number of collective lenses, having an optical axis parallel with the orientation of the storable phosphor, and disposed in a longitudinal direction of the linearly irradiated portion of the storable phosphor sheet, for collecting photostimulated luminescent light emitted from the linearly irradiated portion, or from a portion of a back surface of the storable phosphor sheet corresponding to the linearly irradiated portion; (d) a line sensor, comprising a plurality of photoelectric conversion elements arrayed in at least the longitudinal direction, for receiving the photostimulated luminescent light collected by the collective lenses and then performing photoelectric conversion on the photostimulated luminescent light; (e) scan means for relatively moving one of (1) the line light source and line sensor and (2) the phosphor sheet with respect to the other in a direction differing from the longitudinal direction; and (f) read means for serially reading output of the photoelectric conversion element at each position moved by the scan means, according to the movement.

In the radiation image information reading apparatus of the present invention, it is preferable that the storable phosphor be an alkali halide phosphor having excellent sharpness and sensitivity.

In the case where the line light source and the line sensor are situated on the same side with respect to the phosphor sheet, it is preferable that a reflecting layer be provided on the opposite side of the phosphor sheet for enhancing the efficiency of taking out the photostimulated luminescent light.

Since an increase in the number of pixels, an enhancement in sensitivity, noise reduction, and a reduction in image size are remarkable, it is also preferable that the photoelectric conversion elements constituting the line sensor be charge-coupled devices (CCDs).

To improve light-collecting efficiency, it is preferable that the collective lens be a SELFOC lens.

In the radiation image information reading method and apparatus of the present invention mentioned above, the line light source for irradiating excitation light in line form to the phosphor sheet can employ a fluorescent lamp, a cold cathode fluorescent lamp, an LED array, etc. The line light source may be not only a light source, which itself is in the form of a line, such as the aforementioned fluorescent lamp, etc., but also a light source, from which line excitation light is emitted, such as a broad-area laser, etc. The excitation light may be emitted continuously, or in a pulse form that repeats emission and stop. However, it is desirable from the viewpoint of noise reduction that the excitation light be high-output pulsed light.

It is preferable that the direction in which the line light source and the line sensor are moved relatively with respect to the storable phosphor sheet by the scan means be the transverse direction approximately perpendicular to the longitudinal direction of the line light source and the line sensor. However, the present invention is not limited to the transverse direction. For example, the line light source and the line sensor may be moved obliquely with respect to the longitudinal direction thereof, within a range where excitation light can be irradiated uniformly over approximately the entire surface of the storable phosphor sheet. Also, they may be moved in a zigzag direction.

The line light source and the line sensor may be disposed on the same side with respect to the phosphor sheet, or disposed separately on the opposite sides of the phosphor sheet. In the case where they are disposed separately, the support body for the phosphor sheet needs to be of a type which allows transmittance of photostimulated luminescent light.

Generally, the line sensor has a plurality of photoelectric conversion elements arrayed in the longitudinal direction of the aforementioned irradiated line portion. However, since photostimulated luminescent light spreads in a direction perpendicular to the longitudinal direction, there has been proposed a line sensor in which a plurality of photoelectric conversion elements are also arrayed in that direction. The expression “line sensor comprising a plurality of photoelectric conversion elements arrayed in at least the longitudinal direction” is intended to mean that the radiation image information reading method and apparatus of the present invention can employ the aforementioned two kinds of sensors.

The radiation image information reading method of the present invention employs the storable phosphor sheet, which comprises a storable phosphor having orientation obliquely within a certain plane with respect to the thickness direction of the sheet. In addition, the direction of the optical axis of the collective lens, for collecting photostimulated luminescent light emitted from the storable phosphor sheet onto a line sensor described later, is approximately aligned with the orientation of the storable phosphor. Therefore, photostimulated luminescent light is emitted from the phosphor sheet along the orientation of the phosphor, so that the efficiency of collecting the photostimulated luminescent light can be enhanced.

If the phosphor constituting the storable phosphor sheet employs an alkali halide (MeX:A) phosphor, diffusion of excitation light and photostimulated luminescent light within the sheet can be prevented and spreading of photostimulated luminescent light suppressed, because the oblique pillar-shaped crystal of MeX:A has an optical guide effect such as that of an optical fiber, thereby enhancing light collection efficiency.

In addition, if charge-coupled devices (CCDs) are employed as the photoelectric conversion elements constituting the line sensor, an increase in the number of pixels, an enhancement in sensitivity, a diminishment in noise, and a reduction in image size can be achieved.

Furthermore, if a SELFOC lens is employed as the collective lens, light-collecting efficiency can further be improved.

### BRIEF DESCRIPTION OF THE DRAWINGS

The embodiments of the present invention will be described in further detail with reference to the accompanying drawings wherein:

FIG. 1 is a perspective view showing a radiation image information reading apparatus constructed according to a first embodiment of the present invention;

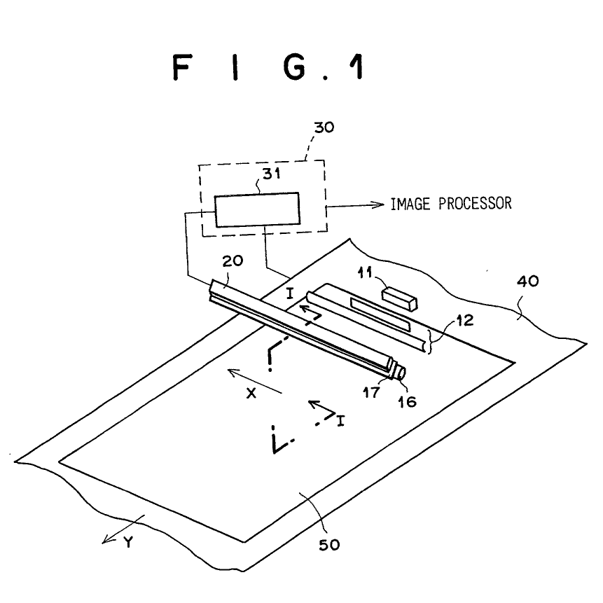

FIG. 2 is a sectional view of the radiation image information reading apparatus taken substantially along line I-I of FIG. 1;

FIG. 3 is an enlarged diagram showing the details of the line sensor of the radiation image information reading apparatus shown in FIG. 1;

FIG. 4 is apart-sectional side view showing a radiation image information reading apparatus constructed according to a second embodiment of the present invention;

FIG. 5 is a diagram showing an example of how photoelectric conversion elements constituting the line sensor are disposed;

FIG. 6 is a diagram showing an example of how photoelectric conversion elements constituting the line sensor are disposed;

FIG. 7 is a diagram used for explaining spreading of photostimulated luminescent light; and

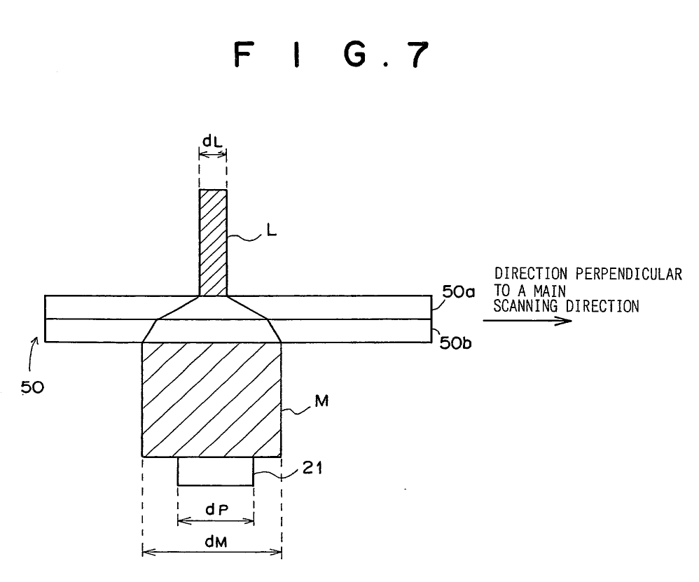

FIG. 8 is a diagram used to explain a storable phosphor having orientation.

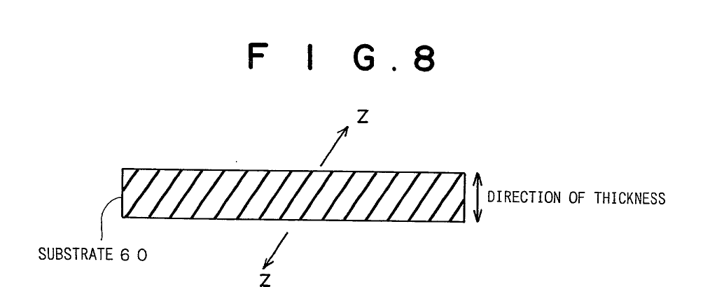

### DESCRIPTION OF THE PREFERRED EMBODIMENTS

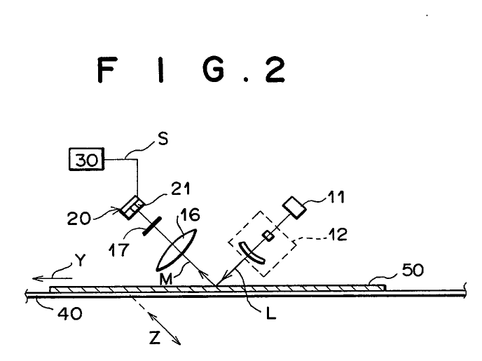

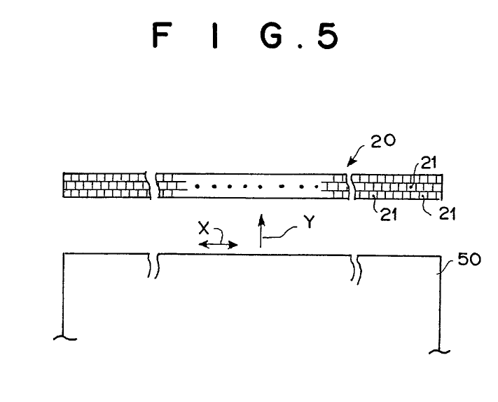

Refer ring now in greater detail to the drawings, there is shown a radiation image information reading apparatus in accordance with a first embodiment of the present invention. Referring to FIG. 5, the radiation image information reading apparatus is equipped with a scanning belt 40, a broad-area laser (BLD) 11, and an optical system 12. The broad-area laser 11 is used for emitting line excitation light L obliquely with respect to the surface of a storable phosphor sheet 50 (hereinafter referred to as a sheet) having an alkali halide phosphor (MeX:A) The optical system 12 consists of a collimator lens for collecting the line excitation light L on the surface of the sheet 50, and a toric lens for expanding the line excitation light L in one direction. The optical system 12 is used for irradiating the line excitation light L to the surface of the phosphor sheet 50. The radiation image information reading apparatus is also equipped with a SELFOC lens array 16, an excitation-light cut filter 17, and a line sensor 20. The SELFOC lens array 16 has an optical axis that is approximately aligned with the orientation of the phosphor of the sheet 50, i.e., the direction of arrow Z shown in FIG. 2. The SELFOC lens array 16 is used for collecting photostimulated luminescent light M, emitted from the sheet 50 by irradiation of the excitation light L, on the line sensor 20. The excitation-light cut filter 17 is used for cutting off the excitation light L which is present in the photostimulated luminescent light M transmitted through the SELFOC lens array 16. The line sensor 20 is used for receiving the photostimulated luminescent light M transmitted through the excitation-light cut filter 17 and then performing photoelectric conversion on the photostimulated luminescent light M. The radiation image information reading apparatus is further equipped with image information read means 30. The image information read means 30 has addition means 31. The addition means 31 is used for adding signals output from the photoelectric conversion elements 21 of the line sensor 20, in accordance with each position on the sheet 50. The image information read means 30 is used for outputting an image signal obtained by the addition means 31.

The image of an emission region of the sheet 50 from which the photostimulated luminescent light M is emitted is formed on the light-receiving surface of the line sensor 20 with a ratio of 1:1 by the SELFOC lens array 16.

The optical system 12, which consists of a collimator lens and a toric lens, magnifies the excitation light L emitted from the broad-area laser 11, to a desired irradiation region onto the phosphor sheet 50.

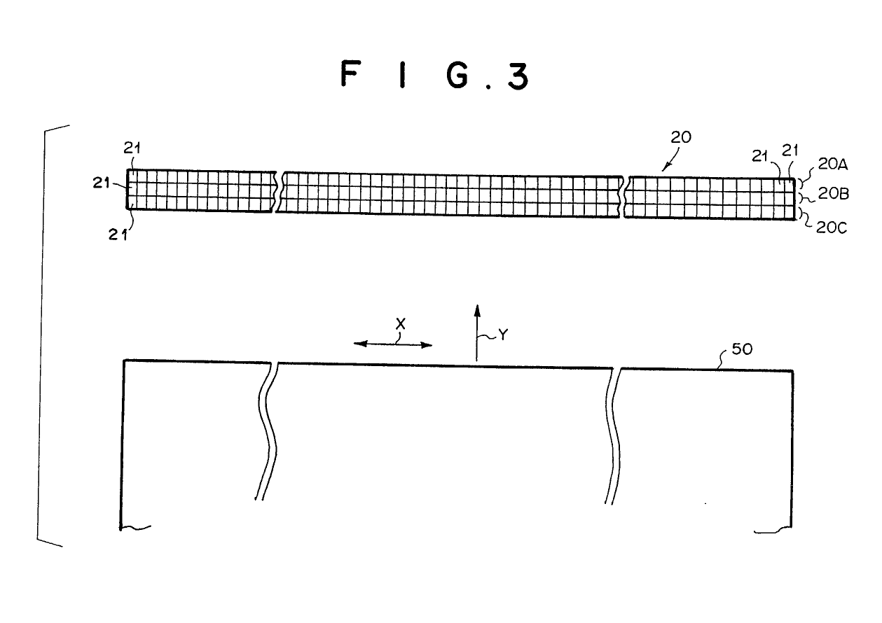

The line sensor 20 has a large number (e.g., 1000 or more) of photoelectric conversion elements 21 adjacent to one another in the direction of arrow X, as shown in FIG. 3. In addition, a plurality of rows of the photoelectric conversion elements 21 extending in the direction of arrow X are disposed in a direction perpendicular to the direction of arrow X. The photoelectric conversion element 21 can employ an amorphous silicon sensor, a charge-coupled device (CCD) sensor, a metal-oxide-semiconductor (MOS) image sensor, etc. The first embodiment employs CCD sensors. The CCD sensors 21 which constitute the line sensor 20 have a light-receiving surface of about 45 μm in length and 45 μm in width.

Now, a description will be given of the operation of the image radiation information reading apparatus of the first embodiment.

Initially, the scanning belt 40 is moved in the direction of arrow Y, whereby the phosphor sheet 50 with radiation image information placed on the scanning belt 40 is conveyed in the direction of arrow Y. The speed at which the phosphor sheet 50 is conveyed is equal to the speed at which the belt 40 is moved. The moving speed of the belt 40 is input to the addition means 30.

On the other hand, the broad-area laser 11 emits line excitation light L with a linewidth of approximately 100 μm obliquely with respect to the surface of the sheet 50. This excitation light L is collimated by the optical system 12 and is incident on the sheet 50. When this occurs, the excitation light L irradiates a line region (approximately 100 μm in linewidth) that extends on the surface of the sheet 50 along the direction of arrow X.

The irradiated line portion of the sheet 50 is excited by the line excitation light L and emits photostimulated luminescent light M which has a strength corresponding to the radiation image information being stored. The photostimulated luminescent light M is incident on the SELFOC lens array 16, which is disposed so that the optical axis thereof is approximately aligned with the direction of arrow Z. The SELFOC lens array 16 cuts off the excitation light L present in the photostimulated luminescent light M. Thereafter, the photostimulated luminescent light M transmitted through the SELFOC lens array 16 is collected on the light-receiving surface of the line sensor 20.

While the first embodiment sets the optical system between the sheet 50 and the line sensor 20 to a 1:1 image system to simplify the description thereof, an enlargement or a reduction image system may be employed. In that case, the size and the number of rows in the linewidth direction of the photoelectric conversion elements 21 of the line sensor 20 are set according to the magnification or demagnification ratio of the enlargement or reduction image system. Note that it is preferable from the viewpoint of enhancing light-collecting efficiency to employ a 1:1 image system or an enlargement image system.

The line sensor 20 performs photoelectric conversion on the photostimulated luminescent light M received by the photoelectric conversion elements 21, and signals Q obtained by the photoelectric conversion are input to the addition means 31.

The addition means 31 cumulates the signals Q from the photoelectric conversion elements 21 (21A, 21B, 21C), based on the moving speed of the scanning belt 40, and adds them according to each portion of the sheet 50. The signal obtained by addition is stored in a memory region provided so as to correspond to each portion of the sheet 50.

The signal stored in the memory is output from the image information read means 30 to an external image processor, etc., and the output signal is used for reproducing a diagnostic image.

Thus, in the radiation image information reading apparatus of the first embodiment, the storable phosphor sheet 50 comprises a storable phosphor that is orientated obliquely with respect to the direction of thickness of the sheet 50, as shown in FIG. 2, and in addition, the optical axis of the SELFOC lens array 16, for collecting the photostimulated luminescent light M, which is emitted by excitation by an excitation light L, irradiated onto said sheet in a direction perpendicular to that of FIG. 2 (X-direction), on the light-receiving surface of the line sensor 20, is approximately aligned with the orientation (Z-direction) of the phosphor of the sheet 50. Therefore, since the photostimulated luminescent light M emitted from the sheet 50 is emitted in the Z-direction where it is concentrated most, the radiation image information reading apparatus of the first embodiment is capable of enhancing the efficiency of collecting the photostimulated luminescent light M.

In addition, since the line sensor 20 in the first embodiment is constructed so that a plurality of CCD sensors 21 are disposed in both the longitudinal direction and the transverse direction of the line sensor 20, the first embodiment is capable of collecting the photostimulated luminescent light M without omission and further enhancing the light-collecting efficiency, even if the light-receiving width of the light-receiving surface of the CCD 21 is less than the linewidth of the excitation light L.

Note that the radiation image information reading apparatus of the present invention is not to be limited to the first embodiment mentioned above. For instance, the present invention can adopt known various constructions, as the light source, the light collecting system between the light source and the sheet, the optical system between the sheet and the line sensor, the line sensor, or the addition means. The radiation image information reading apparatus may further comprise an image processor for performing various signal processes on the signal output from the image information read means. In addition, the reading system may further comprise erasing means for properly removing the radiation energy that still remains in the sheet after excitation.

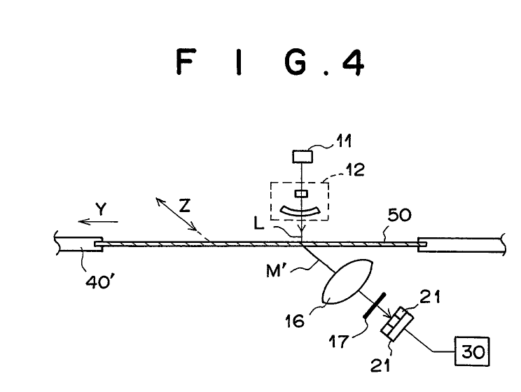

While the radiation image information reading apparatus of the first embodiment adopts the light-reflection construction where the excitation light source 11 and the line sensor 20 are disposed on the same side with respect to the sheet 50, in which the photostimulated luminescent light M is received from the side of the sheet which was irradiated by excitation light L, the radiation image information reading apparatus of the present invention is not limited to such a construction. As shown in FIG. 4, the present invention can employ a storable phosphor sheet having a support body through which photostimulated luminescent light is transmitted, thereby being able to adopt the light-transmission construction where an excitation light source 11 and a line sensor 20 are disposed on different sides across the sheet so that photostimulated luminescent light, emitted from the light-emergence sheet surface opposite to the light-incidence sheet surface, is received.

A radiation image information reading apparatus of a second embodiment of the present invention will be described with reference to FIG. 4. The radiation image information reading apparatus of the second embodiment is equipped with a conveyor belt 40, a broad-area laser 11, and an optical system 12. The conveyor belt 40 is used to support the leading end and trailing end of a storable phosphor sheet 50 (the leading end and trailing end have no radiation image, or are not regions of interest even if a radiation image has been recorded) and convey the phosphor sheet 50 in the direction of arrow Y. The broad-area laser 11 is used to emit line excitation light in a direction substantially normal to the surface of the phosphor sheet 50. The optical system 12 consists of a collimator lens for collecting the line excitation light L on the surface of the sheet 50, and a toric lens for expanding the line excitation light L in one direction. The optical system 12 is used to irradiate the line excitation light L to the surface of the phosphor sheet 50. The radiation image information reading apparatus is further equipped with a SELFOC lens array 16, an excitation-light cut filter 17, a line sensor 20, and an image information read means 30. The SELFOC lens array 16 has an optical axis that is approximately aligned with the orientation (the direction of arrow Z shown in FIG. 4) of an alkali halide phosphor constituting the sheet 50. The SELFOC lens array 16 is used to collect photostimulated luminescent light M′, emitted from the back surface (opposite to the incidence surface) of the sheet 50 by irradiation of the excitation light L, on the line sensor 20. The excitation-light cut filter 17 is used to cut off the excitation light L which is present in the photostimulated luminescent light M′ transmitted through the SELFOC lens array 16. The line sensor 20 is used to receive the photostimulated luminescent light M′ transmitted through the excitation-light cut filter 17 and perform photoelectric conversion on the photostimulated luminescent light M′.

The image of an emission region of the sheet 50 from which the photostimulated luminescent light M′ is emitted is formed on the light-receiving surface of the line sensor 20 with a ratio of 1:1 by the SELFOC lens array 16. The optical system 12, which consists of acollimator lens andatoric lens, magnifies the excitation light L emitted from the broad-area laser 11, to a desired irradiation region onto the sheet 50.

The image information read means 30 has addition means 31. The addition means 31 is used to add signals output from the photoelectric conversion elements 21 of the line sensor 20, in accordance with each position on the sheet 50.

Next, a description will be made of the operation of the image radiation information reading apparatus of the second embodiment shown in FIG. 4.

The conveyor belt 40′ is first moved in the direction of arrow Y, whereby the sheet 50 with radiation image information supported by the conveyor belt 40′ is conveyed in the direction of arrow Y. The speed at which the sheet 50 is conveyed is equal to the speed at which the belt 40′ is moved. The moving speed of the belt 40′ is input to the addition means 31.

On the other hand, the broad-area laser 11 emits line excitation light L of approximately 100 μm in linewidth in a direction approximately normal to the surface of the sheet 50. This excitation light L is collimated by the optical system 12, which is in the optical path thereof, and is incident normally on the sheet 50. The excitation light L irradiates a line region (linewidth d_{L} approximately 100 μm) that extends on the sheet 50 along the direction of arrow X.

The irradiated line portion of the sheet 50 is excited by the line excitation light L and emits photostimulated luminescent light which has a strength corresponding to the radiation image information being stored. At the same time, photostimulated luminescent light M′ transmitted through the transparent support body of the sheet 50 is also emitted from the back surface of the sheet 50.

The photostimulated luminescent light M′ emitted from the back surface of the sheet 50 is incident on the SELFOC lens array 16 disposed so that the optical axis thereof is approximately aligned with the direction of arrow Z. The SELFOC lens array 16 cuts off the excitation light L present in the photostimulated luminescent light M′. The photostimulated luminescent light M′ transmitted through the SELFOC lens array 16 is collected on the light-receiving surface of the line sensor 20.

The operation of the line sensor 20 after light reception is the same as that in the aforementioned first embodiment, so a description thereof is omitted.

As with the first embodiment, the radiation image information reading apparatus of the transmission type of the second embodiment is also capable of enhancing the efficiency of collecting the photostimulated luminescent light M′ that is emitted along the Z-direction where the photostimulated luminescent light M′ is concentrated most, if the storable phosphor of the storable phosphor sheet 50 has a perpendicular orientation (X-direction) with respect to the thickness direction of the sheet 50, and if the optical axis of the SELFOC lens array 16, for collecting the photostimulated luminescent light M on the light-receiving surface of the line sensor 20, is approximately aligned with the orientation (Z-direction) of the storable phosphor of the sheet 50.

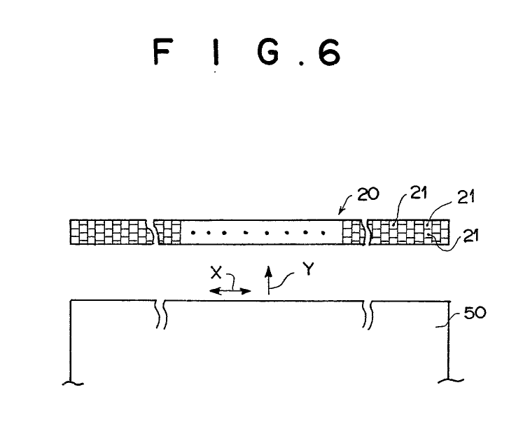

In the line sensor 20 of the first embodiment, as illustrated in FIG. 3, CCD sensors 21 are disposed in matrix form in both the longitudinal direction and the transverse direction of the line sensor 20 so that photostimulated luminescent light can be collected without omission even in the case where the width of the CCD sensor 21 is less than the linewidth of the excitation light. A line sensor to be employed in the radiation image information reading apparatus of the present invention is not limited to that such as shown in FIG. 3. For instance, as shown in FIG. 5, CCD sensors 21 may be disposed straight in the longitudinal direction and zigzag in the transverse direction. Also, as shown in FIG. 6, CCD sensors 21 may be disposed straight in the transverse direction and zigzag in the longitudinal direction.

Furthermore, in the case where the light-receiving width of each photoelectric conversion element 21 of the line sensor 20 is equal to or greater than the linewidth of excitation light, the photoelectric conversion elements 21 can be disposed in a single row in the longitudinal direction.

The radiation image information reading method and apparatus of the present invention can also use a storable radiation-energy-subtraction phosphor sheet instead of the phosphor sheet mentioned above. The radiation-energy-subtraction phosphor sheet can store two different pieces of image information, which differ in radiation energy absorption, of the same subject, and can emit two photostimulated luminescent lightbeams separately from the front and back surfaces thereof according to each image information. In this case, collective lenses, which have an optical axis approximately aligned with the orientation of the storable phosphor of the phosphor sheet, are disposed separately on both sides of the sheet. The photostimulated luminescent light beams collected by each of the collective lenses are received by each of the line sensors, respectively. Furthermore, read means is provided for reading the two pieces of image information from both surfaces of the sheet and then performing a subtraction process on them according to pixels in the front and back surfaces of the sheet.

While certain representative embodiments and details have been shown for the purpose of illustrating the present invention, it will be apparent to those skilled in this art that various changes and modifications may be made without departing from the scope of the invention hereinafter claimed.

What is claimed is:

1. A method of reading radiation image information, comprising the steps of:
preparing a storable phosphor sheet comprising a storable phosphor which has orientation obliquely within a plane with respect to the direction of thickness of said storable phosphor sheet;
linearly irradiating excitation light to a portion of the surface of said storable phosphor sheet in a direction normal to said plane by a line light source to read said radiation image information stored in said storable phosphor sheet;
collecting photostimulated luminescent light emitted from said linearly irradiated portion, or from a portion of a back surface of said storable phosphor sheet corresponding to said linearly irradiated portion, by a plurality of collective lenses having an optical axis parallel with the orientation of said storable phosphor and disposed in a longitudinal direction of the linearly irradiated portion of said storable phosphor sheet;
receiving said photostimulated luminescent light collected by said collective lenses and then performing photoelectric conversion on said photostimulated luminescent light, by a line sensor comprising a plurality of photoelectric conversion elements arrayed in at least said longitudinal direction; and
relatively moving one of (1) said line light source and line sensor and (2) said phosphor sheet with respect to the other in a direction differing from said longitudinal direction, and serially reading output of said photoelectric conversion element according to said movement.

2. An apparatus for reading radiation image information, comprising:
a storable phosphor sheet comprising a storable phosphor which has orientation obliquely within a plane with respect to the direction of thickness of said storable phosphor sheet;
a line light source for linearly irradiating excitation light to a portion of the surface of said storable phosphor sheet in a direction normal to said plane to read said radiation image information stored in said storable phosphor sheet;
a plurality of collective lenses, having an optical axis parallel with the orientation of said storable phosphor, and disposed in a longitudinal direction of the linearly irradiated portion of said storable phosphor sheet, for collecting photostimulated luminescent light emitted from said linearly irradiated portion, or from a portion of a back surface of said storable phosphor sheet corresponding to said linearly irradiated portion;
a line sensor, comprising a plurality of photoelectric conversion elements arrayed in at least said longitudinal direction, for receiving said photostimulated luminescent light collected by said collective lenses and then performing photoelectric conversion on said photostimulated luminescent light;
scan means for relatively moving one of (1) said line light source and line sensor and (2) said phosphor sheet with respect to the other in a direction differing from said longitudinal direction; and
read means for serially reading output of said photoelectric conversion element at each position moved by said scan means, according to said movement.

3. The apparatus as set forth in claim 2, wherein said storable phosphor is an alkali halide phosphor with a pillar-shaped crystal.

4. The apparatus as set forth in claim 2, wherein said photoelectric conversion element is a charge-coupled device.

5. The apparatus as set forth in claim 3, wherein said photoelectric conversion element is a charge-coupled device.

6. The apparatus as set forth in claim 2, wherein said collective lens is a SELFOC lens.

7. The apparatus as set forth in claim 3, wherein said collective lens is a SELFOC lens.

8. The apparatus as set forth in claim 4, wherein said collective lens is a SELFOC lens.
